(19) United States
(12) Patent Application Publication
(10) Pub. No.: US 2021/0134534 A1
(43) Pub. Date: May 6, 2021

(54) POLYTETRAFLUOROETHYLENE FILM FOR ELECTRONIC COMPONENTS

(71) Applicant: W. L. Gore & Associates, Co., Ltd., Minato-ku (JP)

(72) Inventor: Shuhei Toshinari, Minato-ku (JP)

(21) Appl. No.: 17/046,576

(22) PCT Filed: Apr. 18, 2019
(86) PCT No.: PCT/IB2019/000489

§ 371 Date: Oct. 9, 2020

(30) Foreign Application Priority Data
Apr. 24, 2018 (JP) 2018082918

(51) Int. Cl. H01G 9/10; C08L 27/18; H01G 11/80; H01M 50/193

(52) U.S. Cl. CPC H01G 9/10; C08L 27/18; C08L 2201/14; H01M 50/193; H01G 11/80

(57) ABSTRACT

A polytetrafluoroethylene film for electronic components, characterized in that the polytetrafluoroethylene film can have a density of 1.40 g/cm³ or higher and an air impermeability of 3,000 seconds or higher.

### TECHNICAL FIELD

The present disclosure relates to a polytetrafluoroethylene film for electronic components.

### BACKGROUND

In electronic components such as capacitors and batteries, hydrogen gas generated by electrolysis in an electronic component can be discharged by a porous film to the outside of the electronic component.

It is thus an object of the present disclosure is to restrain moisture transmission and to restrain evaporation of an electrolytic solution used for electronic components.

### SUMMARY

In some embodiments, the polytetrafluoroethylene film of the present disclosure for electronic components can have a density of 1.40 g/cm³ or higher and an air impermeability of 3,000 seconds or higher.

In some embodiments, the polytetrafluoroethylene film can have a liquid entry pressure of 0.8 MPa or higher.

In some embodiments, the polytetrafluoroethylene film can have a thickness of 10 to 1,000 μm.

In some embodiments, the polytetrafluoroethylene film can have a porosity of 22% or lower and a density of 1.70 g/cm³ or higher.

In some embodiments, the polytetrafluoroethylene film can have at least one surface with a surface roughness Ra of 0.170 μm or higher.

In some embodiments, the polytetrafluoroethylene film includes a first polytetrafluoroethylene film and a second polytetrafluoroethylene film, and at least one of the first and second polytetrafluoroethylene films is a porous film.

In some embodiments, the polytetrafluoroethylene film comprises a composite film with a first low density polytetrafluoroethylene film, a high density polytetrafluoroethylene film, and a second low density polytetrafluoroethylene film laminated together in this order, and both the first and second low density polytetrafluoroethylene films have a surface roughness Ra of 0.170 μm or higher.

In some embodiments, the polytetrafluoroethylene film comprises two layers consisting of a low density polytetrafluoroethylene film and a high density polytetrafluoroethylene film, and both the low density and high density polytetrafluoroethylene films have a surface roughness Ra of 0.170 μm or higher.

The present disclosure can include an electronic component with an opening, the electronic component comprising the polytetrafluoroethylene film provided on the opening.

The present disclosure can include a capacitor with an opening, the capacitor comprising the polytetrafluoroethylene film provided on the opening.

The present disclosure can include a battery with an opening, the battery comprising the polytetrafluoroethylene film provided on the opening.

By using the polytetrafluoroethylene film of the present disclosure, evaporation of an electrolytic solution used for electronic components such as capacitors and batteries can be restrained, and the amount of moisture transmitted through the film can also be reduced. According to an embodiment, it is possible to provide a polytetrafluoroethylene film having a high liquid entry pressure that can withstand a valve opening test of a safety valve. According to a further embodiment, it is possible to provide a polytetrafluoroethylene film that can be easily disposed (weldable) on an electronic component.

### BRIEF DESCRIPTION OF THE DRAWINGS

FIG. 1 is an exploded perspective view of an aluminum electrolytic capacitor.

FIG. 2 is a cross-sectional view of a sealing plate.

FIG. 3 is a view showing a method of measuring evaporation characteristics of an electrolytic solution.

FIG. 4 is a view showing a method of measuring welding strength.

### DETAILED DESCRIPTION

The polytetrafluoroethylene film for electronic components can comprise one or more layers. In some embodiments, the polytetrafluoroethylene film is made of only polytetrafluoroethylene (hereinafter referred to as PTFE), but an additive or a resin other than PTFE may be contained therein if such content is 5% by mass or lower with respect to the mass of the entire PTFE film. And the mass of the additive or the resin other than PTFE can be 1% by mass or lower. That is, PTFE can be 95% by mass or higher, can also be 99% by mass or higher, and can also be 100% by mass. In this specification, even when a small amount of an additive or a resin other than PTFE is contained in a PTFE film, such a film is included in the PTFE film of the present disclosure.

Hereinafter, various parameters of the PTFE film will be described. In the case where the PTFE film is composed of a plurality of layers, various parameters are values measured in a state where all the layers are laminated.

### (Density)

In some embodiments, the density of the PTFE film can be 0.7 g/cm³ or higher, 0.9 g/cm³ or higher, 1.40 g/cm³ or higher, can be 1.60 g/cm³ or higher. The density of the PTFE film can also be 1.70 g/cm³ or higher, and can also be 1.80 g/cm³ or higher. The upper limit of the density of the PTFE film is not particularly limited, but the upper limit can be, for example, 2.20 g/cm³ or lower. In the present specification, the density (g/cm³) of the PTFE film is a value obtained by measuring the mass W (g) of the PTFE film and the apparent volume V (cm³) including the pore portion, and then dividing the mass W by the volume V. In some embodiments, there is a composite film comprising two PTFE films—a high density PTFE film and a low density PTFE film. In some embodiments, the high density PTFE film can have a density ranging from 1.7 g/cm³ to 2.20 g/cm³. In some embodiments, the high density PTFE film can have a density ranging from 1.8 g/cm³ to 2.10 g/cm³. In some embodiments, the high density PTFE film can have a density ranging from 1.9 g/cm³ to 2.0 g/cm³. In some embodiments, the low density PTFE film can have a density ranging from 0.7 g/cm³ to 1.0 g/cm³. In some embodiments, the low density PTFE film can have a density ranging from 0.75 g/cm³ to 0.95 g/cm³. In some embodiments, the low density PTFE film can have a density ranging from 0.8 g/cm³ to 0.9 g/cm³.

### (Air Impermeability (Gurley Number))

In some embodiments, the air impermeability of the PTFE film can be 3000 seconds or higher, can be 5000 seconds or higher, can also be 10000 seconds or higher, and can also be 30000 seconds or higher, can be 60000 seconds or higher, and can be 99999 seconds or higher. In this specification, the air impermeability of the PTFE film is measured in accordance with JIS P 8117. In some embodiments where there is a composite film comprising two PTFE films—a high density PTFE film and a low density PTFE film, the high density PTFE film can have an air impermeability ranging from 3000 seconds to 99999 seconds. In some embodiments, the high density PTFE film can have an air impermeability ranging from 10000 seconds to 99999 seconds. In some embodiments, the high density PTFE film can have an air impermeability ranging from 60000 seconds to 99999 seconds. In some embodiments, the low density PTFE film can have an air impermeability ranging from 17 seconds to 19 seconds. In some embodiments, the low density PTFE film can have an air impermeability ranging from 17.5 seconds to 18.5 seconds. In some embodiments, the low density PTFE film can have an air impermeability ranging from 17.7 seconds to 18.1 seconds.

### (Porosity)

The porosity of the PTFE film can be 65% or lower, 50% or lower, 41% or lower, or 22% or lower. The porosity of the PTFE film can also be 19% or lower and can also be 16% or lower, 11% or lower, or 5% or lower. The lower limit of the porosity of the PTFE film is not particularly limited, but the lower limit can be, for example, 1% or higher, can be 3% or higher. The method of measuring the porosity will be described later. In some embodiments where there are two PTFE films—a high density PTFE film and a low density PTFE film, the high density PTFE film can have a porosity ranging from 2% to 12%. In some embodiments, the high density PTFE film can have a porosity ranging from 5.5% to 11.5%. In some embodiments, the high density PTFE film can have a porosity ranging from 6% to 11%. In some embodiments, the low density PTFE film can have a porosity ranging from 55% to 65%. In some embodiments, the low density PTFE film can have a porosity ranging from 57% to 61%. In some embodiments, the low density PTFE film can have a porosity ranging from 58% to 59%.

### (Liquid Entry Pressure)

The liquid entry pressure of the PTFE film can be 0.8 MPa or higher, can also be 2 MPa or higher, and can also be 5 MPa or higher. The method of measuring the liquid entry pressure will be described later.

### (Film Thickness)

The film thickness of the PTFE film can be 10 μm or higher, can also be 50 μm or higher, and can also be 100 μm or higher, particularly can be 150 μm or higher. Although the upper limit of the thickness of the PTFE film is not particularly limited, such an upper limit is, for example, 1,000 μm or lower, can be 300 μm or lower, can also be 250 μm or lower. In some embodiments where there is a composite film comprising two PTFE films—a high density PTFE film and a low density PTFE film, the high density PTFE film can have a film thickness ranging from 180 to 200 μm. In some embodiments, the high density PTFE film can have a film thickness ranging from 185 to 195 μm. In some embodiments, the high density PTFE film can have a film thickness ranging from 180 to 190 μm. In some embodiments, the low density PTFE film can have a film thickness ranging from 18.0 to 20.0 μm. In some embodiments, the low density PTFE film can have a film thickness ranging from 18.5 to 19.5 μm. In some embodiments, the low density PTFE film can have a film thickness ranging from 18.0 to 19.0 μm.

### (Piercing Strength)

The piercing strength of the PTFE film can be 12.5 N or higher, can also be 14 N or higher, and can also be 18 N or higher. The upper limit of the piercing strength of the PTFE film is not particularly limited, but the upper limit is, for example, 40 N or lower. In this specification, the piercing strength is measured in accordance with JIS Z 1707.

### (Elongation Percentage at Stress Load)

The elongation percentage when the PTFE film is pierced using a needle with a stress of 5 N can be 1200% or lower, can also be 900% or lower, and can also be 600% or lower. The lower limit of the elongation percentage when the PTFE film is pierced using a needle with a stress of 5 N is not particularly limited, but such a lower limit is, for example, 250% or higher. The method of measuring the elongation percentage at stress load will be described later.

### (Arithmetic Average Roughness Ra)

The arithmetic average roughness Ra of at least one surface of the PTFE film can be 0.170 μm or higher, can also be 0.214 μm or higher, and can also be 0.250 μm or higher. The arithmetic average roughness Ra of both surfaces can also be 0.170 μm or higher. The method of increasing the arithmetic average roughness Ra is not particularly limited and can be realized by a chemical or physical surface treatment, heat treatment in a manufacturing process, or use of constituent materials, or a combination thereof. In this specification, the arithmetic average roughness Ra is measured in accordance with JIS B 0601.

### (Bubble Point Pressure)

The bubble point pressure of the PTFE film can be 660 kPa or higher, can also be 800 kPa or higher. In this specification, the bubble point pressure is measured in accordance with JIS K 3832 (bubble point method).

The maximum pore diameter of the PTFE film can be determined by the following equation. The larger the bubble point pressure, the smaller the maximum pore diameter of the PTFE film.

d=4γ cos θ/P

(In the equation, d is a maximum pore size (m) of the PTFE film, γ is a surface tension (N/m) of isopropyl alcohol, θ is a contact angle (rad) between isopropyl alcohol and the PTFE film, P is a bubble point pressure (kPa))

### (Welding Strength)

The welding strength between the surface having a large arithmetic average roughness Ra of the PTFE film and a polypropylene resin film having a film thickness of 50 μm can be 0.4 kgf or higher, can also be higher than 0.6 kgf. Although the upper limit of the welding strength is not particularly limited, the upper limit is, for example, 2.0 kgf or lower. The method of measuring the welding strength will be described later.

### <Constitution of PTFE Film>

The PTFE film is composed of one layer or a plurality of layers, but the PTFE film can be composed of a plurality of layers and can also be composed of two or three layers. Further, the PTFE film can be corresponds to one of the following types 1 to 5, and can also correspond to any one of types 3 to 5.

### (Types 1 and 2)

The PTFE film consists of only a single layer of PTFE film. The type 1 is produced by a general PTFE film-producing method, and both surfaces are surface treated. On the other hand, in the type 2, surface treatment is performed under heating of only one surface for a short time.

### (Type 3)

A composite PTFE film includes a high density PTFE film and a low density PTFE film, and at least one of said PTFE films is a porous film. The PTFE film can be composed of two layers of the first PTFE film and the second PTFE film, and at least one of said two layers is a porous film.

### (Type 4)

The type 4 is a laminate is also a composite PTFE film formed by stacking a first low density PTFE film (hereinafter referred to as a low density film), a high density PTFE film (hereinafter referred to as a high density film), and a second low density film in this order. In some embodiments both the first low density film and the second low density film have a surface roughness Ra of 0.170 μm or higher.

### (Type 5)

The type 5 is a composite PTFE film comprised of of a low density film and a high density film, and the surface of the low density film side is subjected to the same surface treatment as the type 2. In some embodiments both the low density film and the high density film have a surface roughness Ra of 0.170 μm or higher.

### <Method for Producing PTFE Film>

An example of a method for producing PTFE films of the types 1 to 5 will be described below.

### (Type 1)

First, a liquid lubricant such as solvent naphtha, white oil, naphthenic hydrocarbon, isoparaffinic hydrocarbon, and/or a halide and/or cyanide of isoparaffinic hydrocarbon is added to an unsintered fine powder of PTFE to form a PTFE fine powder paste. Then, the paste is loaded into an extruder and extruded into a tape shape to obtain an extruded PTFE tape. Subsequently, the extruded PTFE tape is rolled with a calender roll, then continuously introduced into a dryer, and subjected to a drying treatment to remove the liquid lubricant, thereby to obtain a dried PTFE tape. Subsequently, the dried PTFE tape is continuously introduced into a stretching apparatus and stretched in the tape advancing direction (MD direction) to obtain a stretched PTFE film. The temperature at the time of stretching can be from 250 to 320° C., can also be from 270 to 310° C. Further, the draw ratio can be 100 to 127%, can also be 101 to 125%. Finally, the porous structure is fixed (heat set) by continuously heat-treating the stretched PTFE film, and is wound up to obtain a PTFE film. In the type 1, the heat treatment time can be less than 10 seconds, can also be 5 seconds or shorter. Further, in the type 1, the heat treatment time can be 1 second or longer, can also be 2 seconds or longer. It is noted that the steps for the stretching, heat treatment, etc. are partially modified from the manufacturing method described in JP-B-51-18991.

### (Type 2)

In the type 2, a stretched PTFE film is obtained in the same manner as in the type 1, except that only one side of the stretched PTFE film is heat treated. In the type 2, the draw ratio can be higher than 100%, can also be 110% or higher, and can be 220% or lower, can also be 200% or lower. In addition, the heat treatment time can be shorter than that of the type 1, and the heat treatment time can be less than 2 seconds, can also be 1.5 seconds or shorter, and can also be 1 second or shorter. Further, in the type 2, the heat treatment time can be 0.1 second or longer, can also be 0.3 seconds or longer. The PTFE film can also be produced under the same conditions as in the type 1.

### (Type 3)

In the type 3, the method of producing the PTFE film differs from that in the type 1 in combining the biaxially stretched tape described later as a low density film (porous film) on a dried PTFE tape before stretching. In the type 3, the draw ratio can be 100% or higher, and can be 130% or lower, can also be 120% or lower. For the type 3, the heat treatment time can be shorter than that of the type 1, and the heat treatment time can be less than 3 seconds, can also be 2 seconds or shorter. Further, in the type 3, the heat treatment time can be 0.1 second or longer, can also be 0.3 seconds or longer. The PTFE film can also be produced under the same conditions as in the type 1. It is noted that the step of combining the biaxially stretched tape on the dried PTFE tape is a modification of the production method described in JP-A-57-131236.

The biaxially stretched tape is obtained by preparing an extruded PTFE tape in the same manner as in the type 1, rolling the extruded PTFE tape with a calender roll, biaxially stretching the PTFE tape in the longitudinal direction and the transverse direction, and drying the biaxially stretched tape in the same manner as in the type 1. The longitudinal draw ratio can be 200 to 800%, can also be 300 to 700%, and the transverse draw ratio can be 500 to 1300%, can also be 700 to 1200%.

### (Type 4)

First, the porous film (low density film) used in the type 3, the stretched PTFE film (high density film) used in the type 1, and the porous film (low density film) used in the type 3 are laminated in this order and stretched in the tape advancing direction (MD direction) to obtain a stretched PTFE laminate. Finally, the stretched PTFE laminate is continuously heat treated to fix (heat set) the porous structure and wound up to obtain a PTFE laminate. In the type 4, the draw ratio can be 100% or higher and can be 150% or lower, can also be 130% or lower. In the type 4, the heat treatment time can be less than 3 seconds, can also be 2 seconds or shorter. Further, in the type 4, the heat treatment time can be 0.1 second or longer, can also be 0.3 seconds or longer. The PTFE film can also be produced under the same conditions as in the type 1.

### (Type 5)

First, the stretched PTFE film (high density film) used in the type 1 and the porous film (low density film) used in the type 3 are laminated and then stretched in the tape advancing direction (MD direction) to obtain a stretched PTFE laminate. Finally, only the surface on the low density side of the stretched PTFE laminate is subjected to continuous heat treatment to fix (heat set) the porous structure and then wound up to obtain a PTFE laminate. In the type 5, the draw ratio can be higher than 100%, can also be 110% or higher. Further, in the type 5, the draw ratio can be 150% or lower, can also be 130% or lower. In the type 5, the heat treatment time can be less than 2 seconds, can also be 1.5 seconds or shorter, and can also be 1 second or shorter. In addition, in the type 5, the heat treatment time can be 0.1 seconds or longer, can also be 0.3 seconds or longer. Except for the above conditions, it is preferable to produce the PTFE film under the same conditions as in the type 1.

### <Electronic Component>

An example of an electronic component in which the PTFE film of the present disclosure is used is an electronic component with an opening, wherein the polytetrafluoroethylene film is provided on the opening. Further, in some embodiments the electronic component is a capacitor or a battery. Specifically, the electronic component in which the PTFE film of the present disclosure is used can be a capacitor with an opening, with the polytetrafluoroethylene film provided on the opening, or a battery with an opening, with the polytetrafluoroethylene film provided on the opening. In some embodiments, the PTFE film is a composite film comprising a low density PTFE film and a high density PTFE film. In such embodiments, the composite PTFE film can be disposed on the electronic component with the low density PTFE film oriented proximally relative to electronic component and the high density PTFE film oriented distally relative to the electronic component. In some embodiments, the composite film is attached to the electronic component, for example, by welding the low density PTFE film portion of the composite film to an opening of the electronic component.

Hereinafter, an aluminum electrolytic capacitor having a PTFE film will be described as an example of an electronic component in which the PTFE film of the present disclosure is used.

FIG. 1 is an exploded perspective view of an aluminum electrolytic capacitor. In an aluminum electrolytic capacitor 1, a capacitor element 3 is accommodated in a bottomed cylindrical metal case 2, the opening of the metal case 2 is sealed with a sealing plate 4, and on the bottom surface of the metal case 2, a safety valve 5 is provided. The safety valve 5 is designed to be opened when the internal pressure rises in the event of an abnormality such as an overvoltage being applied to the aluminum electrolytic capacitor 1. The capacitor element 3 is configured by winding an anode foil 6 and a cathode foil 7 between which a separator 8 is interposed, and a pair of lead wires 9 are led out from the anode foil 6 and the cathode foil 7. The separator 8 is impregnated with an electrolytic solution comprising a solvent (for example, ethylene glycol or γ-butyrolactone) and an electrolyte salt.

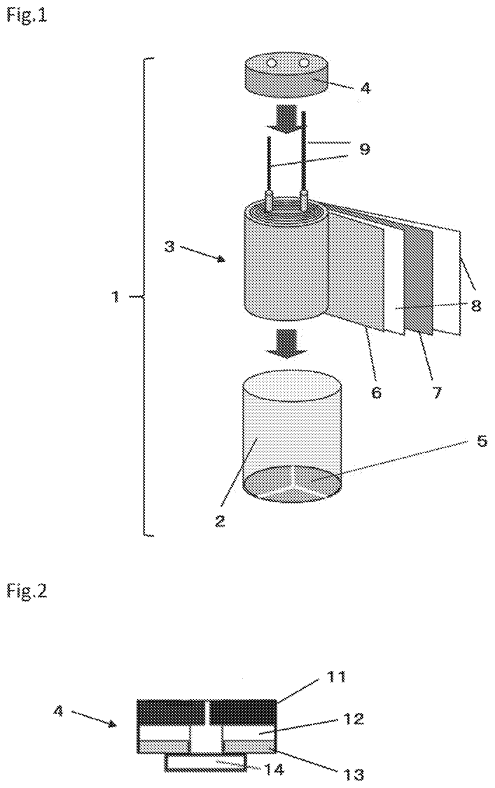

FIG. 2 is a cross-sectional view of a sealing plate 4. The sealing plate 4 comprises a rubber layer 11, a phenol resin film 12, a polypropylene resin film 13, and a PTFE film 14 laminated in this order. In some embodiments the PTFE film 14 is a composite PTFE film comprised of a high density PTFE film and a low density PTFE film. As the rubber layer 11, the phenol resin film 12, and the polypropylene resin film 13, for example, a rubber layer 11 having a thickness of 1.0 mm, a phenol resin film 12 having a thickness of 2.5 to 3 mm, and a polypropylene resin film 13 having a thickness of 100 μm can be used. It is noted that a hole is formed in each of the rubber 11, the phenol resin film 12, and the polypropylene resin film 13. For example, a hole having a diameter of 1 mm or smaller is formed in the rubber layer 11, and a hole having a diameter of 1 mm is formed in each of the phenol resin film 12 and the polypropylene resin film 13. The rubber layer 11 having a hole, the phenol resin film 12 having a hole, and the polypropylene resin film 13 having a hole are stacked to overlap the holes with each other. A PTFE film 14 is laminated on the polypropylene resin film 13 to close the hole formed on the polypropylene resin film 13. The PTFE film 14 is welded on the polypropylene resin film 13. As a welding method, for example, while applying a pressing force of 4 kgf to a welding portion, the welding portion is heated with a welding tip (not shown) to 380° C. for 3 seconds, whereby the PTFE film 14 can be welded on the polypropylene resin film 13.

The PTFE film 14 and the polypropylene resin film 13 may be welded by laser welding or ultrasonic welding or may be fastened using a compressive part such as a rubber O-ring or may be molded by coextrusion.

### EXAMPLES

Hereinafter, the present disclosure will be described in more detail with reference to Examples, but the following Examples do not limit the present disclosure, and various modifications can be made within the scope not departing from the gist of the present disclosure.

Next, the measurement and evaluation method used in Examples will be described below. The parameters of the PTFE films of Examples and Comparative Examples are shown in Table 1, and the air impermeabilities (Gurley number), densities, porosities, and thicknesses of the high density film portion and the low density film portion of Examples 16 to 20 are shown in Table 2.

### (Air Impermeability (Gurley Number))

The air impermeability of the PTFE film was measured using Oken Air Permeability Tester KG1 manufactured by Asahi Seiko Co., Ltd in accordance with JIS P 8117. In Examples 16 to 20 described later, measurement and evaluation were performed using PTFE laminates as a PTFE film (the same also applies to the following measurement/evaluation methods).

### (Density)

The mass W (g) of the PTFE film and the apparent volume V (cm³) including the pore portion were measured, and the mass W was divided by the volume V to calculate the density p (g/cm³) of the PTFE film.

### (Porosity)

Using the density p (g/cm³) and the true density (2.2 g/cm³ in the case of the PTFE resin) when no pores were formed at all, the porosity of the PTFE film was calculated according to the following equation:

Porosity (%)=[(2.2−ρ)/2.2)]×100

### (Liquid Entry Pressure)

A stainless plate having an opening diameter of 1 mm and a thickness of 0.5 mm was provided on the opposite side of the pressurized surface of the PTFE film, and the liquid pressure of ethylene glycol at 100° C. was controlled so that a predetermined pressure was applied to the PTFE film. The predetermined pressure was maintained for 5 minutes and the presence or absence of the liquid that passes through the PTFE film was visually confirmed. When the predetermined pressure was successfully held for 5 minutes, the pressure applied to the PTFE film was increased and the above test was carried out again, and the liquid pressure when the liquid passed through the PTFE film was defined as a liquid entry pressure. The liquid temperature of ethylene glycol was kept at 100° C. assuming the rated temperature of the capacitor at 105° C.

### (Film Thickness)

The average thickness measured using a dial thickness gauge (“SM-1201” manufactured by TECLOCK Corporation), with no load other than the body spring load applied, was taken as a thickness of the PTFE film.

### (Piercing Strength)

The piercing strength was measured in accordance with JIS Z 1707 as follows. Using a TENSILON Universal Material Testing Machine RTG-1210 manufactured by A&D Co., Ltd., the PTFE film was fixed and pierced with a needle having a diameter of 2.0 mm and a tip of hemispherical shape with a radius of 1.0 mm at a speed of 50±5 mm per minute, and the maximum stress up to the penetration of the needle was measured. The maximum stress was defined as a piercing strength.

### (Elongation Percentage at Stress Load)

Using a TENSILON Universal Material Testing Machine RTG-1210 manufactured by A&D Co., Ltd., the PTFE film was fixed and pierced with a needle having a diameter of 2.0 mm and a tip of hemispherical shape with a radius of 1.0 mm at a speed of 50±5 mm per minute. The amount of displacement (μm) of the needle when the PTFE film was pierced with a needle at a stress of 5 N was measured, that is, the needle was moved from a state where the needle was in contact with the surface of the PTFE film to a state where the needle was pierced at a stress of 5 N, and the displacement amount (μm) of the needle was measured. The percentage obtained by dividing the displacement amount (μm) of the needle by the thickness (μm) of the PTFE film was taken as an elongation percentage of the PTFE film at 5 N stress load.

### (Arithmetic Average Roughness Ra)

The arithmetic average roughness Ra was measured in accordance with JIS B 0601 as follows. The measuring visual field was determined using a laser microscope VK 9710 manufactured by Keyence Corporation, equipped with an objective lens (magnification: 150 times; CF IC EPI PLAN Apo 150× manufactured by Nikon Corporation), and such measurement was performed in the entire visual field. Using the obtained data, arithmetic average roughness Ra was calculated with a short wavelength cutoff λs of 0.25 μm and a long wavelength cutoff 2× of 80 μm. In all the Examples and Comparative Examples, the arithmetic average roughness Ra of both surfaces of the PTFE film was measured, and the surface having the large arithmetic average roughness Ra was taken as an arithmetic average roughness Ra of the A surface, and the surface having the small arithmetic average roughness Ra was taken as an arithmetic average roughness Ra of the B surface.

### (Bubble Point Pressure)

The bubble point pressure was measured according to JIS K 3832 (bubble point method) as follows. The PTFE film was immersed in isopropyl alcohol, and the pressure of the air was raised from the lower side of the PTFE film. The pressure at the time when a bubble was initially generated from the hole having the maximum pore diameter of the PTFE film was defined as a bubble point pressure P (Pa).

### (Evaporation Characteristics of Electrolytic Solution)

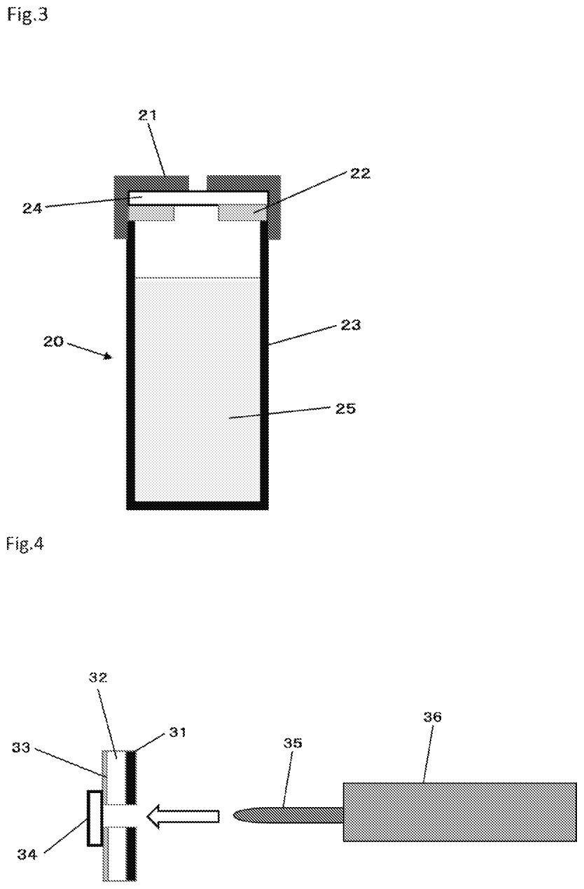

As shown in FIG. 3, a vial 20 (Mighty Vial No. 7 manufactured by Maruemu Corporation; capacity 50 ml) provided with a cap 21, a rubber gasket 22, and a bottle body 23 was prepared, and a hole having a diameter of 2.0 mm was formed in the center portion of the cap 21, and a hole having a diameter of 5.0 mm was formed in the center portion of the rubber gasket 22. Next, a PTFE film 24 was sandwiched between the cap 21 and the rubber gasket 22 to close the hole formed in the cap 21 and the hole formed in the rubber gasket 22. Subsequently, about 8.0 g of ethylene glycol 25 was placed in the bottle body and sealed. Thereafter, the vial 20 was placed in an oven at 105° C. for 24 hours, and the amount of decrease in ethylene glycol after 24 hours was measured. Such decrease amount was divided by the evaporation area (hole area of rubber gasket: 1.96×10⁻⁵ m²) of the PTFE film and the measurement time (24 hours) to obtain a weight loss rate (g/m²·h), which was evaluated according to the following criteria.

A: The weight loss rate is less than 50 g/m²·h.

B: The weight loss rate is 50 to 200 g/m²·h.

C: The weight loss rate is greater than 200 g/m²·h.

### (Moisture Transmission Suppression Characteristics)

The moisture transmission suppression characteristics can be evaluated by measuring the water vapor suppression rate. Specifically, the water vapor transmission rate of the PTFE film was measured according to JIS K 7129 and was then evaluated according to the following criteria.

A: The water vapor transmission rate is less than 5 g/m²0.24 h.

B: The water vapor transmission rate is 5 to 500 g/m²0.24 h.

C: The water vapor transmission rate is greater than 500 g/m²0.24 h.

### (Welding Strength)

### i) Preparation of Sealing Plate

As shown in FIG. 4, a laminate was produced by laminating a rubber 31 having a thickness of 1.0 mm, a phenol resin film 32 having a thickness of 2.0 mm and a polypropylene resin film 33 having a thickness of 50 nm in this order. Next, the laminate was cut into 2 cm square, and a hole having a diameter of 2.5 mm was formed so that the hole penetrates all the layers. Subsequently, a welding portion was heated with a welding tip at 380° C. for 3 seconds under a pressing force of 4 kgf to weld the A surface of the PTFE film 34 onto the polypropylene resin film 33, and the hole formed in the polypropylene resin film 33 was closed, thereby to produce a sealing plate.

### ii) Measurement of Welding Strength

First, a semicircular needle 35 having a diameter of 2.0 mm and and a tip of hemispherical shape with a radius of 1.0 mm was fixed to a force gauge DS2-50N manufactured by IMADA Co., Ltd. Next, by using a force gauge stand MH-1000N-E manufactured by IMADA Co. Ltd., a force gauge 36 to which the needle 35 is fixed was moved to thrust the needle 35 from the rubber side of a sealing plate 4 toward the hole of 2.5 mm in diameter formed on the sealing plate at a rate of 193 mm per minute until the PTFE film was peeled off from the sealing plate. Peak strength (kgf) indicated the force gauge when the PTFE film was peeled off was read and taken as a welding strength, which was then evaluated according to the following criteria.

A: The welding strength is greater than 0.6 kgf.

B: The welding strength is 0.4 to 0.6 kgf.

C: The welding strength is less than 0.4 kgf.

### Example 1

Solvent naphtha was added to Fluon (registered trademark) CD123 manufactured by Asahi Glass Co., Ltd., which is an unsintered fine powder of PTFE, to form a PTFE fine powder paste. Next, the paste was loaded into an extruder and extruded into a tape shape having a width of 16 cm and a thickness of 750 μm to obtain an extruded PTFE tape. Thereafter, the extruded PTFE tape was rolled with a calender roll to a thickness of 220 μm, then continuously introduced into a dryer, and dried at a temperature of 300° C. to remove the solvent naphtha, thereby to obtain a dried PTFE tape. Subsequently, the dried PTFE tape was continuously introduced into a stretching apparatus and stretched at a draw ratio of 125% in the tape advancing direction (MD direction) at a temperature of 300° C. to obtain a stretched PTFE film. Finally, the stretched PTFE film was heat-treated continuously at 360° C. for 3 seconds to fix (heat set) the porous structure and then wound up to obtain a PTFE film.

### Example 2

A PTFE film was prepared in the same manner as in Example 1 except that the draw ratio was set to 115%.

### Example 3

A PTFE film was prepared in the same manner as in Example 1 except that the draw ratio was set to 112%.

### Example 4

A PTFE film was prepared in the same manner as in Example 1 except that the draw ratio was set to 110%.

### Example 5

A PTFE film was prepared in the same manner as in Example 1 except that the draw ratio was set to 108%.

### Example 6

A PTFE film was prepared in the same manner as in Example 1 except that the draw ratio was set to 106%.

### Example 7

A PTFE film was prepared in the same manner as in Example 1 except that the draw ratio was set to 107%.

### Example 8

A PTFE film was prepared in the same manner as in Example 1 except that the draw ratio was set to 101%.

### Example 9

First, a dried PTFE tape was prepared in the same manner as in Example 1. Next, the dried PTFE tape was continuously introduced into a stretching apparatus and stretched at a draw ratio of 110% in the tape advancing direction (MD direction) at a temperature of 300° C. to obtain a stretched PTFE film. Finally, only one surface of the stretched PTFE film was heat-treated continuously at 360° C. for 0.9 seconds to fix (heat set) the porous structure and then wound up to obtain a PTFE film.

### Example 10

A PTFE film was prepared in the same manner as in Example 9 except that the heat treatment time was set to 0.7 seconds.

### Example 11

A PTFE film was prepared in the same manner as in Example 9 except that the heat treatment time was set to 0.6 seconds.

### Example 12

A PTFE film was prepared in the same manner as in Example 9 except that the draw ratio was set to 145% and the heat treatment time was set to 0.7 seconds.

### Example 13

A PTFE film was prepared in the same manner as in Example 9 except that the draw ratio was set to 163% and the heat treatment time was set to 0.7 seconds.

### Example 14

A PTFE film was prepared in the same manner as in Example 9 except that the draw ratio was set to 183% and the heat treatment time was set to 0.7 seconds.

### Example 15

A PTFE film was prepared in the same manner as in Example 9 except that the draw ratio was set to 196% and the heat treatment time was set to 0.7 seconds.

### Example 16

First, a dried PTFE tape was prepared as a high density film in the same manner as in Example 1. Next, an extruded PTFE tape was prepared in the same manner as in Example 1 and rolled with a calender roll to a thickness of 500 μm. Thereafter, the rolled PTFE tape was biaxially stretched at a longitudinal draw ratio of 500% and a transverse draw ratio of 1000%. Subsequently, the biaxially stretched tape was introduced into a dryer, dried at a temperature of 300° C. to remove the solvent naphtha, and dried to obtain a biaxially stretched film having a thickness of 35 μm and a density of 0.45 g/cm³ as a porous film (low density film).

The first high density film and the low density film were cut into the same size, combined between rolls, and then stretched at a draw ratio of 116% in the tape advancing direction (MD direction) at a temperature of 300° C. by a stretching apparatus, thereby to obtain a stretched PTFE laminate. Finally, the stretched PTFE laminate was heat-treated continuously at 350° C. for 1 second to fix (heat set) the porous structure and then wound up to obtain a composite PTFE film.

### Example 17

A composite PTFE film was prepared in the same manner as in Example 16 except that the draw ratio was set to 105%.

### Example 18

A composite PTFE film was prepared in the same manner as in Example 16 except that the draw ratio was set to 100% (stretching was not performed).

### Example 19

First, an extruded PTFE film was prepared in the same manner as in Example 1 and a stretched PTFE film was prepared as a high density film in the same manner as in Example 1 except that the extruded PTFE tape was rolled with a calender roll to a thickness of 220 μm. Next, a porous, low density PTFE film was prepared in the same manner as in Example 16, and two porous films were prepared in Example 19.

The high density PTFE film and the two porous low density PTFE films were each cut into the same size, and the porous film, the high density film, and the porous film were combined in this order between rolls, and then they were stretched at a draw ratio of 116% in the tape advancing direction (MD direction) at a temperature of 300° C. by a stretching apparatus to obtain a stretched PTFE laminate. Finally, the stretched PTFE laminate was heat-treated continuously at 350° C. for 1 second to fix (heat set) the porous structure and then wound up to obtain a composite PTFE film.

### Example 20

A stretched PTFE film was prepared as a high density film in the same manner as in Example 1. Next, a porous film (low density film) was prepared in the same manner as in Example 16. The high density film and the porous film were each cut into the same size, combined between rolls, and then stretched at a draw ratio of 110% in the tape advancing direction (MD direction) at a temperature of 300° C. by a stretching apparatus, thereby to obtain a stretched PTFE laminate. Finally, only the surface on the low density side of the stretched PTFE laminate was continuously heat-treated at 360° C. for 0.9 seconds to fix (heat set) the porous structure and then wound up to obtain a composite PTFE

### Comparative Example 1

The extruded PTFE tape described in Example 1 was rolled with a calender roll to a thickness of 400 μm, introduced into a dryer, dried at a temperature of 300° C. to remove the solvent naphtha, thereby to obtain a dried PTFE tape. Subsequently, the dried PTFE tape was continuously introduced into a stretching apparatus and stretched at a draw ratio of 600% in the tape advancing direction (MD direction) at a temperature of 300° C. to obtain a stretched PTFE film. Finally, the stretched PTFE film was heat-treated continuously at 380° C. for 3 seconds to fix (heat set) the porous structure and then wound up to obtain a PTFE film.

### Comparative Example 2

The extruded PTFE tape described in Example 1 was rolled with a calender roll to a thickness of 380 μm, introduced into a dryer, and dried at a temperature of 300° C. to remove the solvent naphtha, thereby to obtain a dried PTFE tape. Subsequently, the dried PTFE tape was continuously introduced into a stretching apparatus and stretched at a draw ratio of 225% in the tape advancing direction (MD direction) at a temperature of 300° C. to obtain a stretched PTFE film. Finally, the stretched PTFE film was heat-treated continuously at 380° C. for 3 seconds to fix (heat set) the porous structure and then wound up to obtain a PTFE film.

### Comparative Example 3

The extruded PTFE tape described in Example 1 was rolled with a calender roll to a thickness of 220 μm, introduced into a dryer, dried at a temperature of 300° C. to remove the solvent naphtha, thereby to obtain a dried PTFE tape. Subsequently, the dried PTFE tape was continuously introduced into a stretching apparatus and stretched at a draw ratio of 130% in the tape advancing direction (MD direction) at a temperature of 300° C. to obtain a stretched PTFE film. Finally, the stretched PTFE film was heat-treated continuously at 360° C. for 3 seconds to fix (heat set) the porous structure and then wound up to obtain a PTFE film.

### Comparative Example 4

A PTFE film was prepared in the same manner as in Comparative Example 3 except that the extruded PTFE film was rolled to a thickness of 200 μm and stretched at a draw ratio of 145%.

### Comparative Example 5

A PTFE film was prepared in the same manner as in Comparative Example 3 except that the extruded PTFE film was rolled to a thickness of 200 μm and stretched at a draw ratio of 140%.

### Comparative Example 6

A PTFE film was prepared in the same manner as in Comparative Example 3 except that the extruded PTFE film was rolled to a thickness of 200 μm and stretched at a draw ratio of 135%.

### Comparative Example 7

A PTFE film was prepared in the same manner as in Comparative Example 3 except that the extruded PTFE film was rolled to a thickness of 200 μm and stretched at a draw ratio of 130%.

TABLE 1

| | Air | | | | | | Elongation | Arithmetic |
|---|---|---|---|---|---|---|---|---|
| | Impermeability | | | Liquid | | | Precentage | Average |
| | (Gurley | | | Entry | Film | Piercing | of Stress | Roughness Ra |
| | Number) | Density | Porosity | Pressure | Thickness | Strength | Load | A surface |
| | second | g/cm³ | % | MPa | μm | N | % | μm |
| Comparative | 1 | 0.35 | 32.6 | 0.03 | 300 | 7.5 | 693.3 | 1.124 |
| Example 1 | | | | | | | | |
| Comparative | 12 | 0.53 | 63.3 | 0.05 | 295 | 12.0 | 478.0 | 0.808 |
| Example 2 | | | | | | | | |
| Comparative | 448 | 1.32 | 38.0 | 0.2 | 197 | 9.7 | 834.0 | 0.283 |
| Example 3 | | | | | | | | |
| Comparative | 591 | 1.41 | 36.2 | 0.4 | 180 | 9.8 | 881.2 | 0.233 |
| Example 4 | | | | | | | | |
| Comparative | 719 | 1.44 | 34.3 | 0.5 | 195 | 9.9 | 812.4 | 0.243 |
| Example 5 | | | | | | | | |
| Comparative | 1725 | 1.53 | 27.9 | 0.8 | 186 | 10.0 | 1098.9 | 0.212 |
| Example 6 | | | | | | | | |
| Comparative | 2120 | 1.81 | 23.4 | 0.7 | 190 | 12.0 | 1174.2 | 0.213 |
| Example 7 | | | | | | | | |
| Example 1 | 7000 | 1.78 | 18.0 | 0.8 | 182 | 15.1 | 895.8 | 0.186 |
| Example 2 | 62306 | 1.91 | 11.1 | 1.4 | 182 | 16.3 | 576.9 | 0.096 |
| Example 3 | ≥99999 | 1.98 | 10.1 | 1.4 | 183 | 15.5 | 683.1 | 0.090 |
| Example 4 | ≥99999 | 1.99 | 8.4 | 1.8 | 186 | 16.9 | 655.9 | 0.088 |
| Example 5 | ≥99999 | 2.03 | 7.6 | 2.0 | 184 | 15.5 | 658.8 | 0.090 |
| Example 6 | ≥99999 | 2.07 | 2.7 | 4.0 | 186 | 22.2 | 568.8 | 0.084 |
| Example 7 | ≥99999 | 2.08 | 8.4 | >8 | 190 | 16.8 | 467.7 | 0.089 |
| Example 8 | ≥99999 | 2.18 | 0.3 | >5 | 210 | 33.9 | 314.3 | 0.072 |
| Example 9 | ≥99999 | 1.95 | 11.4 | 4.0 | 185 | 15.0 | 976.9 | 0.111 |
| Example 10 | ≥99999 | 1.87 | 15.2 | 3.5 | 193 | 14.8 | 968.5 | 0.171 |
| Example 11 | ≥99999 | 1.50 | 18.3 | 2.0 | 197 | 14.7 | 1157.4 | 0.214 |
| Example 12 | ≥99999 | 1.73 | 21.0 | 2.0 | 132 | 36.3 | 1005.2 | 0.131 |
| Example 13 | ≥99999 | 1.59 | 27.5 | 1.6 | 187 | 26.0 | 1097.6 | 0.144 |
| Example 14 | 35722 | 1.53 | 30.2 | 1.4 | 184 | 25.9 | 771.7 | 0.153 |
| Example 15 | 33722 | 1.46 | 33.5 | 1 | 183 | 25.0 | 1131.1 | 0.133 |
| Example 16 | ≥99999 | 1.57 | 15.1 | >5 | 200 | 20.4 | 575.0 | 0.291 |
| Example 17 | ≥99999 | 1.94 | 11.7 | >5 | 207 | 20.9 | 641.1 | 0.288 |
| Example 18 | ≥99999 | 2.07 | 5.8 | >5 | 210 | 20.7 | 533.3 | 0.293 |
| Example 19 | ≥99999 | 1.89 | 10.2 | >5 | 240 | 21.2 | 526.9 | 0.294 |
| Example 20 | ≥99999 | 1.92 | 10.8 | >5 | 214 | 20.1 | 569.5 | 0.281 |
| | | Arithmetic | | | | | | |
| | | Average | | Bubble | Transpiration | Moisture | | |
| | | Roughness Ra | | Point | Characteristics | Transmission | Wielding | |
| | | B surface | A surface/ | Pressure | of Electrolytic | Suppression | Strength | |
| | | μm | B surface | kPa | Solution | Characteristics | Evaluation | kgf |
| | Comparative | 1.012 | 1.11 | 13 | C | C | A | 1.698 |
| | Example 1 | | | | | | | |
| | Comparative | 0.808 | 1.00 | 64 | C | C | A | 1.451 |
| | Example 2 | | | | | | | |
| | Comparative | 0.259 | 1.03 | 256 | C | C | A | 0.67 |
| | Example 3 | | | | | | | |
| | Comparative | 0.211 | 1.10 | 291 | C | C | A | 0.613 |
| | Example 4 | | | | | | | |
| | Comparative | 0.215 | 1.13 | 381 | C | C | A | 0.622 |
| | Example 5 | | | | | | | |
| | Comparative | 0.199 | 1.07 | 919 | C | C | B | 0.593 |
| | Example 6 | | | | | | | |
| | Comparative | 0.203 | 1.05 | 854 | C | C | B | 0.557 |
| | Example 7 | | | | | | | |
| | Example 1 | 0.181 | 1.03 | 722 | B | B | B | 0.420 |
| | Example 2 | 0.092 | 1.04 | ≥883 | A | B | C | 0.249 |
| | Example 3 | 0.088 | 1.02 | ≥883 | A | B | C | 0.221 |
| | Example 4 | 0.082 | 1.07 | ≥883 | A | B | C | 0.203 |
| | Example 5 | 0.065 | 1.01 | ≥883 | A | A | C | 0.193 |
| | Example 6 | 0.082 | 1.02 | ≥883 | A | A | C | 0.177 |
| | Example 7 | 0.072 | 1.24 | ≥883 | A | A | C | 0.289 |
| | Example 8 | 0.007 | 1.07 | ≥883 | A | A | C | 0.046 |
| | Example 9 | 0.076 | 1.46 | ≥883 | A | B | C | 0.385 |
| | Example 10 | 0.092 | 1.86 | ≥883 | A | B | B | 0.405 |
| | Example 11 | 0.101 | 2.12 | ≥883 | A | B | A | 0.620 |
| | Example 12 | 0.070 | 1.87 | ≥883 | A | B | C | 0.396 |
| | Example 13 | 0.085 | 1.69 | 792 | B | B | C | 0.244 |
| | Example 14 | 0.099 | 1.55 | 714 | B | B | C | 0.256 |
| | Example 15 | 0.093 | 1.43 | 864 | B | B | C | 0.247 |
| | Example 16 | 0.069 | 4.22 | ≥883 | A | B | A | 1.227 |
| | Example 17 | 0.071 | 4.00 | ≥883 | A | B | A | 1.361 |
| | Example 18 | 0.082 | 3.57 | ≥883 | A | A | A | 1.319 |
| | Example 19 | 0.283 | 1.04 | ≥883 | A | B | A | 1.332 |
| | Example 20 | 0.212 | 1.33 | ≥883 | A | B | A | 1.158 |

TABLE 2

| | High-density film portion | | | | Low-density film portion | | | |
|---|---|---|---|---|---|---|---|---|
| | Air | | | | Air | | | |
| | Impermeability | | | | Impermeability | | | |
| | (Gurley | | | Film | (Gurley | | | Film |
| | Number) | Density | Porosity | Thickness | Number) | Density | Porosity | Thickness |
| | second | g/cm³ | % | μm | second | g/cm³ | % | μm |
| Example 16 | ≥99999 | 1.95 | 11.2 | 182 | 17.5 | 0.95 | 57 | 18 |
| Example 17 | ≥99999 | 2.06 | 6.3 | 187 | 17.8 | 0.89 | 59.6 | 18 |
| Example 18 | ≥99999 | 2.14 | 2.7 | 196 | 18.1 | 0.86 | 60.9 | 18 |
| Example 19 | ≥99999 | 2.01 | 5.2 | 200 | 17.9 | 0.75 | 65.7 | 20 |
| Example 20 | ≥99999 | 2.02 | 5.4 | 197 | 17.7 | 0.91 | 58.2 | 19 |

When the PTFE films of Examples 1 to 15, each having a density of 1.40 g/cm³ or higher and an air impermeability of 3000 seconds or higher, were used, the evaporation of the electrolytic solution and the transmission of moisture were restrained, and the PTFE films of Examples 1 to 15 had a high liquid entry pressure which could withstand a valve opening test of a safety valve. Also, when the PTFE laminates of Examples 16 to 20, each having a density of 1.40 g/cm³ or higher and an air impermeability of 3000 seconds or higher, the evaporation of the electrolytic solution and the transmission of moisture were restrained. On the other hand, when Comparative Examples 1 to 7, each having an air impermeability of less than 3000 seconds, were used, the electrolytic solution was abundantly vaporized, moisture was transmitted through the film, and the PTFE films of Comparative Examples 1 to 7 had no high liquid entry pressure capable of withstanding a valve opening test of a safety valve.

1. An electronic component comprising:
an electrolytic solution therewithin; and
a composite film which covers an opening of the electronic component:
the composite film comprising:
a high density polytetrafluoroethylene film having a density of 1.7 g/cm³ to 2.20 g/cm³ and an air impermeability of 3,000 seconds to 99,999 seconds;
a low density polytetrafluoroethylene film having a density of 0.7 g/cm³ to 1.0 g/cm³ and an air impermeability ranging from 17 seconds to 19 seconds;
wherein the electrolytic solution evaporates through the composite film at a rate of less than 50 g/m²·h.

2. The electronic component of claim 1, wherein the composite film is disposed directly on the opening of the electronic component with the low density polytetrafluoroethylene film disposed proximally relative to the electronic component and the high density polytetrafluoroethylene film disposed distally relative to the electronic component.

3. The electronic component of claim 1, wherein the composite film is incorporated into a sealing plate, wherein the sealing plate covers the opening of the electronic component.

4. The electronic component of claim 3, wherein the sealing plate comprises:
a rubber layer;
a resin film;
a polypropylene film; and
the composite film layer;
wherein the resin film and the polypropylene film are sandwiched between the rubber layer and the composite film layer;
wherein the composite film layer is positioned proximally relative to the electronic component; and
wherein the rubber layer is positioned distally relative to the electronic component.

5. The electronic component of claim 1, wherein the composite film has a liquid entry pressure of 0.8 MPa to 5.0 MPa.

6. The electronic component of claim 1, wherein the high density polytetrafluoroethylene film has a thickness ranging from 180 μm to 200 μm.

7. The electronic component of claim 1, wherein the low density polytetrafluoroethylene film has a thickness ranging from 18.0 μm to 20.0 μm.

8. The electronic component of claim 1, wherein the high density polytetrafluoroethylene film has a porosity ranging from 2% to 12%.

9. The electronic component of claim 1, wherein the low density polytetrafluoroethylene film has a porosity ranging from 55% to 65%.

10. The electronic component of claim 1, wherein at least one surface of the composite film has an average surface roughness (Rₐ) ranging from 0.17 μm to 0.24 μm.

11. The electronic component of claim 1, wherein both the high density and low density polytetrafluoroethylene films have an average surface roughness (Rₐ) ranging from 0.17 μm to 0.24 μm.

12. The electronic component of claim 1, wherein the electronic component is a capacitor.

13. The electronic component of claim 1, wherein the electronic component is a battery.

14. (canceled)

15. (canceled)

16. (canceled)

17. (canceled)

18. (canceled)

19. (canceled)

20. (canceled)

21. (canceled)

23. (canceled)

24. (canceled)
